(19) United States
(12) Patent Application Publication
(10) Pub. No.: US 2022/0077764 A1
(43) Pub. Date: Mar. 10, 2022

(54) ELECTRIC ENERGY CONVERSION AND CONTROL DEVICE AND ENERGY STORAGE SYSTEM HAVING THE SAME

(71) Applicant: Envision Energy CO.,LTD, Jiangsu (CN)

(72) Inventors: Hongwu SHE, Jiangsu (CN); Lei LI, Jiangsu (CN); Liang CAO, Jiangsu (CN); Hao MENG, Jiangsu (CN); Jianning Wang, Jiangsu (CN); Wenyu LI, Jiangsu (CN); Weijun ZHAO, Jiangsu (CN); Lei ZHANG, Jiangsu (CN)

(73) Assignee: Envision Energy CO.,LTD, Jiangsu (CN)

(21) Appl. No.: 17/416,524

(22) PCT Filed: Nov. 27, 2019
(86) PCT No.: PCT/CN2019/121247

§ 371 Date: Jun. 21, 2021

(30) Foreign Application Priority Data
Dec. 28, 2018 (CN) 201811623859.2

(51) Int. Cl. H02M 1/32; H02J 7/04; H02M 7/217; H02J 3/32; H02J 7/00; H02M 7/537

(52) U.S. Cl. CPC H02M 1/32; H02J 7/04; H02M 7/537; H02J 3/32; H02J 7/0029; H02M 7/217

(57) ABSTRACT

An electric energy conversion and control device includes an electric energy conversion unit configured to perform electric energy conversion, a connection end of energy storage battery pack configured to connect to the energy storage battery pack, a safety device connected in a connection line between the electric energy conversion unit and the connection end of the energy storage battery pack to protect the electric energy conversion and control device from damage caused by excessive current, a DC circuit breaker connected in the connection circuit, a main contactor connected in the connection line, and a control module configured to control the electric energy conversion unit and monitor and manage the energy storage battery pack. The invention also relates to an energy storage system.

### BACKGROUND

### Technical Field

The present invention relates generally to the field of energy storage system, in particular, to an electric energy conversion and control device. In addition, the present invention also relates to an energy storage system with the device.

### Description of Related Art

The current energy storage system is mainly composed of energy storage battery pack, BMS (Battery Management System), PCS (Power Conversion System, or energy storage converter), control unit and other components. Among them, the energy storage battery pack (Lithium-ion batteries, or other types of energy storage battery packs) is mainly used for energy storage, BMS is used for status monitoring and protection of energy storage battery packs, PCS is used for the electric energy conversion of charging from the AC grid to energy storage battery packs and discharging from the energy storage battery packs to the AC grid, and the control unit is used to receive the charging and discharging scheduling instructions and realize the control of the PCS.

The Chinese patent CN201310302750.X, entitled “a new type of battery energy storage system and its function integration design”, discloses a new type of battery energy storage system and its function integration design method. The system includes an energy storage unit and an energy storage monitoring system EMS. The energy storage unit includes an energy storage battery pack EB, a battery management system BMS, and an energy storage converter PCS. The energy storage battery pack EB is connected to a battery management system BMS, and the battery management system BMS are respectively connected to the energy storage battery pack EB and the energy storage converter PCS. The input end of the energy storage monitoring system EMS is connected to the output end of the battery management system BMS, and the energy storage converter PCS and the energy storage monitoring system EMS can communicate with each other. In this patent, the battery management system BMS and the power converter are separate, which results in redundancy of space and device.

The Chinese patent application CN201710693689.4, entitled “system and method for energy storage and energy management based on a distributed control mode”, discloses system and method for energy storage and energy management based on a distributed control mode. The system includes an energy management parent module, several distributed energy storage subsystems, and distributed energy management sub-modules corresponding to each distributed energy storage subsystem. The distributed energy storage subsystem includes energy storage battery packs, the energy monitoring unit BMS and the energy storage converter PCS. The energy storage battery pack is connected to the power distribution network system via the energy storage converter PCS, the energy storage monitoring unit BMS is electrically connected to the energy storage battery pack, and the distribution energy management sub-modules are respectively connected to the energy storage monitoring unit BMS, the energy storage converter PCS, and the energy management parent module through the communication network. In this patent, a distributed control mode is adopted. However, the battery management system BMS and PCS are still separate, which also results in redundancy of space and device.

It can be seen from the above that one of the problems of the existing energy storage system is that the BMS and PCS are separate components, which occupy significant space respectively. In addition, they are usually designed by different teams, have redundant parts, and are costly.

### SUMMARY

Starting from the prior art, the task of the present invention is to provide an electrical energy conversion and control device and an energy storage system having the same, through which a compact electrical energy conversion and control device may be provided, thereby greatly improving system integration. In addition, the redundant components can be reduced without reducing safety, thereby significantly reducing cost.

In a first aspect of the present invention, the task is to provide an electric energy conversion and control device, comprising:

an electric energy conversion unit, configured to convert AC electric energy obtained from the grid into DC electric energy and/or convert DC electric energy stored by the energy storage battery pack into AC electric energy or DC electric energy;

a connection end of the energy storage battery pack, configured to connect to the energy storage battery pack;

a safety device, connected in a connection line between the electric energy conversion unit and the connection end of the energy storage battery pack to protect the electric energy conversion and control device from damage caused by excessive current;

a DC circuit breaker, connected in the connection line between the electric energy conversion unit and the connection end of the energy storage battery pack;

a main contactor, connected in the connection line between the electric energy conversion unit and the connection end of the energy storage battery pack; and

a control module, configured to perform electric energy conversion management and/or charging and discharging management operations of an energy storage battery pack system.

In a preferred solution of the present invention, it is specified that the device further includes a pre-charging circuit comprising a pre-charging contactor, a pre-charging fuse, and a pre-charging resistor, wherein the pre-charging contactor, the pre-charging fuse and the pre-charging resistor are connected in series with each other, and the series circuit of the pre-charging contactor, the pre-charging fuse and the pre-charging resistor is connected in parallel with the main contactor. Through this preferred solution, the electric energy conversion unit and the energy storage battery pack may be better protected from the damage caused by excessive instantaneous charging current.

In another preferred solution of the present invention, it is specified that the control module includes:

a battery monitoring unit, configured to detect state parameters of the energy storage battery pack;

a battery control unit, configured to perform the following actions:
determining a health state and/or a charging state of the energy storage battery pack according to the state parameters of the energy storage battery pack; and/or
controlling on and off of the main contactor and the pre-charged contactor; and an electric energy conversion control unit, configured to perform the following actions:
controlling the electric energy conversion unit to charge and discharge the energy storage battery pack or monitor the state of the energy storage battery pack.

Through this preferred solution, real-time monitoring of health state (such as whether there is overcurrent, overvoltage, or overtemperature, etc.) and/or the charging state (such as whether it is in a charging state, power level, etc.) of the energy storage battery pack can be realized, thereby extending the life of energy storage battery packs or improving safety. The state parameters include, for example, current, voltage, temperature, and so on.

In a second aspect of the present invention, the aforementioned task is solved by an energy storage system comprising:

an electric energy conversion and control devices, comprising:
an electric energy conversion unit, configured to convert AC electric energy obtained from the electric grid into DC electric energy and/or convert DC electric energy stored by an energy storage battery pack into AC electric energy or DC electric energy;
a safety device, connected in a connection line between the electric energy conversion unit and the energy storage battery pack to protect the electric energy conversion and control device from damage caused by excessive current;
a DC circuit breaker, connected in the connection line between the electric energy conversion unit and the energy storage battery pack;
a main contactor, connected in the connection line between the electric energy conversion unit and the energy storage battery pack;
a pre-charging circuit, comprising a pre-charging contactor, a pre-charging fuse, and a pre-charging resistor, wherein the pre-charging contactor, the pre-charging fuse, and the pre-charging resistor are connected in series with each other, and a series circuit of the pre-charging contactor, the pre-charging fuse, and the pre-charging resistor is connected in parallel with the main contactor; and
a control module, configured to perform power supply management operations;

an energy storage battery pack, configured to store electrical energy; and

a housing, configured to accommodate the components of the energy storage system.

In a preferred solution of the present invention, it is specified that the safety device is a fusing type fuse. Through this preferred solution, a low-cost and reliable overcurrent protection can be realized. It should be noted here that other types of safety devices are also conceivable, for example, other overcurrent protection devices, such as current relays.

In another preferred solution of the present invention, it is specified that the system further includes an AC circuit breaker, which is connected between an input end of the electric grid and the electric energy conversion and control device. Through this preferred solution, the energy storage system can be protected from damage caused by the excessive AC loads.

In an extended solution of the present invention, it is specified that the energy storage battery pack includes a plurality of rechargeable batteries connected in series and/or in parallel. Through this extended solution, the capacity of the energy storage system can be expanded.

In an extended solution of the present invention, it is specified that the electric energy conversion unit includes at least one three-phase AC/DC electric energy conversion device.

In an extended solution of the present invention, it is specified that the electric energy conversion unit is composed of at least one AC/DC converter and at least one DC/DC electric energy conversion device in series. Through this extended solution, the normal working range of the DC voltage of the energy storage battery pack can be expanded.

In an extended solution of the present invention, it is specified that the electric energy conversion unit is composed of a plurality of electric energy conversion devices with lower power in parallel. Through this extended solution, the power of the energy storage system can be expanded.

In another preferred solution of the present invention, it is specified that the system includes only one safety device and/or only one DC circuit breaker and/or only one main contactor. Through this preferred solution, the number of components can be reduced, thereby significantly reducing costs and improving integration.

The present invention has at least the following beneficial effects. (1) The scheme of the present invention integrates the electric energy conversion function and the BMS battery management function into a single device, which reduces the equipment space. (2) The present invention ensures safety during the integration process, meanwhile redundant safety devices, DC circuit breakers, main contactors and other components are eliminated, thereby reducing equipment costs and further improving integration. (3) The present invention also eliminates the separate current detection circuit and voltage detection circuit in the BMS battery management system, instead, for example, a DC current and voltage detection circuit in the electric energy conversion unit can be used.

### BRIEF DESCRIPTION OF THE DRAWINGS

The present invention will be further explained below with reference to specific embodiments in conjunction with the drawings.

FIG. 1 shows a schematic diagram of an energy storage system according to the present invention; and

FIG. 2 shows the appearance of the energy storage system according to the present invention.

### DESCRIPTION OF THE EMBODIMENTS

It should be pointed out that the components in the drawings may be shown exaggeratedly for illustration purposes, and not necessarily in correct proportions. In the drawings, the same reference numerals are assigned to the same or the same components.

In the present invention, unless otherwise specified, “arranged on”, “arranged above”, and “arranged over” do not exclude the presence of intermediates between the two.

In the present invention, each embodiment is only intended to illustrate the solution of the present invention, and should not be construed as restrictive.

In the present invention, unless otherwise specified, the quantifiers “one” and “a” and “an” do not exclude the scenario of multiple elements.

It should also be pointed out here that in the embodiments of the present invention, for the sake of clarity and simplicity, only a part of the parts or components may be shown, but those of ordinary skill in the art can understand that under the teaching of the present invention, the scene needs to add required parts or components.

It should also be pointed out here that within the scope of the present invention, the terms “same”, “equal”, “equal to” and other terms do not mean that the two values are absolutely equal, but allow certain reasonable errors, that is to say, the wording also covers “substantially the same”, “substantially equal”, and “substantially equal to”.

In addition, the number of the steps of each method of the present invention does not limit the execution order of the method steps. Unless otherwise specified, the method steps can be performed in a different order.

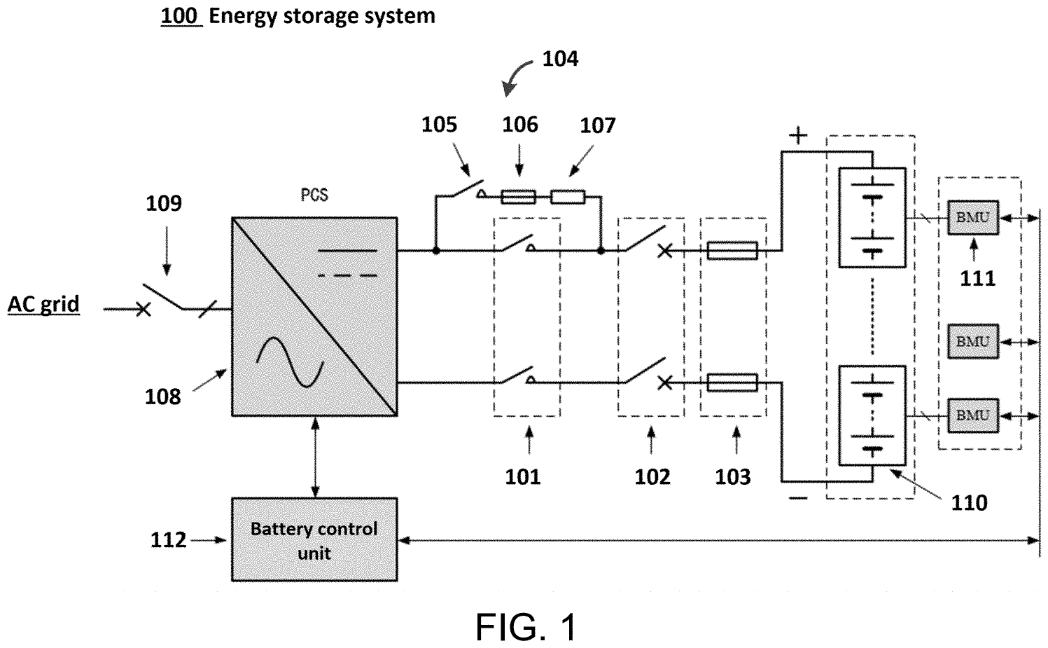

FIG. 1 shows a schematic diagram of an energy storage system 100 according to the present invention. The energy storage system 100 can be used, for example, as an energy storage or backup power source for power generation equipment, such as a wind generator. The energy storage system 100 can also be used as a building energy storage or backup power source. Other application scenarios are also conceivable.

As shown in FIG. 1, the energy storage system 100 includes an electrical energy conversion and control device, which includes an electrical energy conversion unit 108, a main contactor 101, a DC circuit breaker 102, a safety device 103, and a control module, wherein the control module includes a battery monitoring unit 111 and battery control unit 112. The components of the energy storage system 100 are described in detail below.

The electric energy conversion unit 108 is configured to convert AC power obtained from the AC power grid into DC power to charge the energy storage battery pack 110 and/or convert the DC power stored by the energy storage battery pack 110 into AC power to feed the AC power grid, or convert DC power into DC power with different electrical parameters to charge other batteries. The electric energy conversion unit 108 may be a commercially available electric energy conversion unit, such as a converter or a electric energy converter. The electrical energy conversion unit 108 itself may include a detection circuit for detecting electrical parameters, such as current, voltage, or electric energy, of the energy storage system 100. These electrical parameters may be fed back to the control module for status detection, automatic control, etc.

A safety device 103 is connected in the connection line between the electric energy conversion unit and the connection end of the energy storage battery pack to protect the electric energy conversion and control device 100 from damage caused by excessive current damage. The safety device 103 may be a fusing type fuse, for example. Other types of safety devices are also conceivable, for example, other overcurrent protection devices, such as current relays.

The DC circuit breaker 102 is connected in the connection line between the electric energy conversion unit and the energy storage battery pack 110. The DC circuit breaker 102 is arranged on the DC side and used to open and close the DC connection line. The DC circuit breaker 102 is, for example, a high-voltage circuit breaker.

The main contactor 101 is connected in the connection line between the electric energy conversion unit 108 and the energy storage battery pack 110. The main contactor 101 is used to control the on-off of the DC connection line. The main contactor 101 is, for example, an electromagnetic relay. Its principle is that the current flowing in the coil generates a magnetic field to close the contacts to achieve the on-off of the control circuit.

The control module is used to perform electric energy management operations and includes a battery monitoring unit 111 and a battery control unit 112. The battery monitoring unit 111 is configured to obtain the state parameters of the energy storage battery pack, such as current, voltage, and temperature, for example, from the electric energy conversion unit 108. The battery control unit 112 is configured to determine the health state and/or the charging state of the energy storage battery pack, and/or control the on-off of the pre-charge contactor 105 according to the state parameters of the energy storage battery pack 110. In addition, the control module also includes an electric energy conversion control unit (not shown), which is configured to control the electric energy conversion device unit to charge, discharge or monitor the state of the energy storage battery pack.

The electric energy conversion and control device may optionally include a pre-charging circuit 104, which includes a pre-charging contactor 105, a pre-charging fuse 106, and a pre-charging resistor 107. The pre-charging contactor 105 and the pre-charging fuse 106 and the pre-charging resistor 107 are connected in series with each other, and the series circuit of the pre-charging contactor 105, the pre-charging fuse 106, and the pre-charging resistor 107 is connected with the main contactor 101 in parallel. The function of the pre-charging circuit 104 is to avoid excessive charging current during charging in the energy storage system, so as to prevent damage to the components of the energy storage system.

The energy storage system 100 also includes an energy storage battery pack 110, which is configured to store electrical energy. The energy storage battery pack 110 includes, for example, a plurality of rechargeable batteries, such as accumulators, connected in series or in parallel. However, it should be pointed out that in the present invention, the energy storage battery pack also covers the case of a single battery or accumulator.

The energy storage system 100 further includes a housing (not shown) which is configured to accommodate the aforementioned components of the energy storage system.

The energy storage system 100 may optionally include an AC circuit breaker 109 connected between the grid input end and the electrical energy conversion and control device 108. The AC circuit breaker 109 is arranged on the AC side and used to open or close the AC circuit.

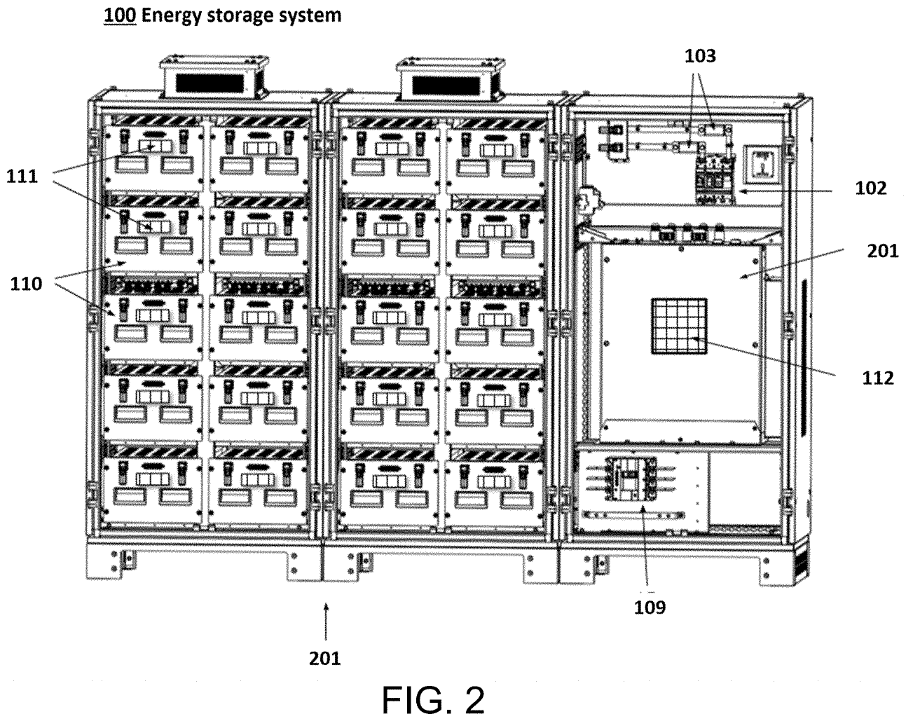

FIG. 2 shows the appearance of the energy storage system 100 according to the present invention.

As shown in FIG. 2, the energy storage system 100 is arranged in a single cabinet 201, in which a power unit 201 is also arranged in addition to the energy storage system 100.

PCS DC contactor and BMS DC contactor are combined, using only one DC contactor (main contactor); PCS DC fuse and BMS DC fuse are combined, using only one DC fuse (safety device) 103; PCS DC circuit breaker is combined with the BMS DC circuit breaker, using only one DC circuit breaker 102. The PCS control unit is combined with the BMS control unit BCU, and using only one control unit 112. The current detection circuit and voltage detection circuit in the control module and the DC current detection circuits inside the PCS and the voltage detection circuits of the energy storage system 100 are combined, and only one such circuit is required. Here, the DC circuit breaker 102, the fuse 103, the DC contactor, the pre-charging contactor, the pre-charging fuse, the pre-charging resistor and other devices are arranged in a single cabinet 201, and no additional battery high-voltage box is needed.

After such integration, the protection function of the original system is still guaranteed, but the system cost is reduced. A set of contactors, a set of fuses, and a set of circuit breakers are omitted therein, and the battery high-voltage box shell is no longer needed.

In combination with the above embodiment, it can be known the present invention has at least the following beneficial effects. (1) The scheme of the present invention integrates the electric energy conversion function and the BMS battery management function into a single device, which reduces the equipment space. (2) The present invention ensures safety during the integration process, meanwhile redundant safety devices 103, DC circuit breakers101, main contactors 103 and other components are eliminated, thereby reducing equipment costs and further improving integration. (3) The present invention also eliminates separate current detection circuit and voltage detection circuit in the BMS battery management system, instead, for example, a DC current and voltage detection circuit in the electric energy conversion unit can be used.

Although some embodiments of the present invention have been described in this application document, those skilled in the art can understand that these embodiments are only shown as examples. Under the teaching of the present invention, those skilled in the art can think of numerous variations, alternatives and improvements without going beyond the scope of the present invention. The appended claims are intended to define the scope of the present invention, and thereby cover the methods and structures within the scope of these claims and their equivalent electric energy conversion.

What is claimed is:

1. An electric energy conversion and control device, comprising:
an electric energy conversion unit, configured to convert AC electric energy obtained from an electric grid into DC electric energy and/or convert DC electric energy stored by an energy storage battery pack into AC electric energy or DC electric energy;
a connection end of the energy storage battery pack, configured to connect to the energy storage battery pack;
a safety device, connected in a connection line between the electric energy conversion unit and the connection end of the energy storage battery pack to protect the electric energy conversion and control device from damage caused by excessive current;
a DC circuit breaker, connected in the connection line between the electric energy conversion unit and the connection end of the energy storage battery pack;
a main contactor, connected in the connection line between the electric energy conversion unit and the connection end of the energy storage battery pack; and
a control module, configured to perform charge and discharge management and/or battery management operations of an energy storage system.

2. The device according to claim 1, further comprising a pre-charging circuit comprising a pre-charging contactor, a pre-charging fuse and a pre-charging resistor, wherein the pre-charging contactor, the pre-charging fuse and the pre-charging resistors are connected in series with each other, and a series circuit of the pre-charging contactor, the pre-charging fuse, and the pre-charging resistor is connected in parallel with the main contactor.

3. The device according to claim 2, wherein the control module comprises:
a battery monitoring unit, configured to obtain state parameters of the energy storage battery pack;
a battery control unit, configured to perform the following actions:
determining a health state and/or a charging state of the energy storage battery pack according to the state parameters of the energy storage battery pack; and/or
controlling on and off of the main contactor and the pre-charged contactor; and
an electric energy conversion control unit, configured to perform the following actions:
controlling the electric energy conversion unit to charge and discharge the energy storage battery pack or monitor the state of the energy storage battery pack.

4. An energy storage system, comprising:
an electric energy conversion and control device, comprising:
an electric energy conversion unit, configured to convert AC electric energy obtained from an electric grid into DC electric energy and/or convert DC electric energy stored by an energy storage battery pack into AC electric energy or DC electric energy;
a safety device, connected in a connection line between the electric energy conversion unit and the energy storage battery pack to protect the electric energy conversion and control device from damage caused by excessive current;
a DC circuit breaker, connected in the connection line between the electric energy conversion unit and the energy storage battery pack;
a main contactor, connected in the connection line between the electric energy conversion unit and the energy storage battery pack;
a pre-charging circuit, comprising a pre-charging contactor, a pre-charging fuse, and a pre-charging resistor, wherein the pre-charging contactor, the pre-charging fuse, and the pre-charging resistor are connected in series with each other, and a series circuit of the pre-charging contactor, the pre-charging fuse and the pre-charging resistor is connected in parallel with the main contactor; and
a control module, configured to perform electric energy management operations;
an energy storage battery pack, configured to store electrical energy; and
a housing, configured to accommodate components of the energy storage system.

5. The system according to claim 4, wherein the safety device is a fusing type fuse.

6. The system according to claim 4, further comprising an AC circuit breaker which is connected between an input end of the electric grid and the electric energy conversion and control device.

7. The system according to claim 4, wherein the energy storage battery pack comprises a plurality of rechargeable batteries connected in series or in parallel.

8. The system according to claim 4, wherein the system comprises only one safety device and/or only one DC circuit breaker and/or only one main contactor.

9. The system according to claim 4, wherein the electric energy conversion unit comprises at least one three-phase AC/DC electric energy conversion device.

10. The system according to claim 4, wherein the electric energy conversion unit comprises at least one AC/DC converter and at least one DC/DC electric energy conversion device connected in series with each other.

11. The system according to claim 4, wherein the electric energy conversion unit comprises a plurality of electric energy conversion devices connected in parallel with each other.
